(19) United States
(12) Patent Application Publication
(10) Pub. No.: US 2010/0279573 A1
(43) Pub. Date: Nov. 4, 2010

(54) FORMULATION AND METHOD FOR DUST CONTROL OF FIBRE INSULATION

(76) Inventor: Laurence Sinnige, Ontario (CA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/680,942

(22) PCT Filed: Oct. 10, 2008
(86) PCT No.: PCT/CA08/01777

§ 371 Date: Jul. 19, 2010

Related U.S. Application Data
(60) Provisional application No. 60/979,014, filed on Oct. 10, 2007.

(51) Int. Cl. C09K 3/22; C08L 91/00; D04H 13/00

(52) U.S. Cl. 442/327; 252/88.2; 524/313

(57) ABSTRACT

An aqueous anti-dusting emulsion formulation for use in the manufacture of fibre wool insulation comprises (by weight): a) less than 90% a petroleum hydrocarbon; b) 10%-100% of a triglyceride; and, c) 1%-10% of a surfactant such as an ammonium or sodium salt of lignosulphonic acid. Also provided are fibre wool insulation products incorporating such formulations and methods of making such insulation products.

### CROSS REFERENCE TO PRIOR APPLICATIONS

The present application claims priority from U.S. patent application No. 60/979,014, filed on Oct. 10, 2007, the entire contents of which are incorporated herein by reference.

### FIELD OF THE INVENTION

The present invention relates to formulations used to control dust generated in using fibre insulation products. More specifically, the invention relates to an aqueous emulsion of a petroleum based material and a triglyceride component that is usable as an anti-dusting formulation for fibreglass and mineral wool insulation products and which forms a stable composition when mixed with a binder.

### BACKGROUND OF THE INVENTION

In order to insulate dwellings from the elements, it is common to utilize fibre based insulation products embedded into walls, attics and crawispaces etc. Such fibre based insulation products generally comprise fibreglass, mineral wool products and the like. These products are generally available in the form of batts or blankets, which are laid together to form an envelope around the perimeter of the dwelling. In the manufacture of such fibre insulation, it is common to apply a binder, such as a thermoset binder, to the fibres in order to allow the fibre to adhere together. One common binder is a phenolic resin (e.g. an aqueous phenol-formaldehyde condensation product) such as that commercially available from Dynea (www.dynea.com) under product no. 1957-16.

In the process of forming such batt insulation, a considerable amount of dust is generated. For example, in the case of fibreglass batt insulation, manipulation of the batts results in breakage of the glass fibres, which, in turn, results in the formation of tiny glass fragments that no longer have the properties of a fibre. These tiny fragments can form small dust particles that cause irritation of the skin, eyes, nose and throat of the installer. In some cases, inhalation of the dust particles can lead to serious medical consequences. For this reason, it is known in the art to incorporate a de-dusting or anti-dusting agent into the glass fibres during the manufacturing process. One common anti-dusting additive comprises mineral oil. Another form of insulation is referred to as “loose fill”, wherein baits of insulation, such as fibreglass insulation, is comminuted and blown into a space to be insulated. As will be understood, this manipulation of the fibreglass product also generates a fair amount of the aforementioned dust particles.

The use of anti-dusting agents, in particular mineral oil, in fibre insulation has been discussed in the prior art. For example, U.S. Pat. No. 3,861,895 teaches a formulation wherein mineral oil is substituted with a polyalkene glycol component. U.S. Pat. No. 5,683,810 teaches a method wherein mineral oil is used as an anti-dusting component but without any binder. U.S. Pat. No. 6,964,744 teaches the use of mineral oil combined with a non-ionic and/or cationic surfactant to improve the effectiveness of the mineral oil.

In the manufacture of fibre insulation wherein both a binder and anti-dusting agent are used, it is advantageous to apply both components simultaneously to the fibres so as increase production efficiency. However, such as in the case of a phenolic resin binder and a mineral oil anti-dusting agent, it is found that the formulation results in the rapid separation of the aqueous binder solution and the non-aqueous anti-dusting component. This phase separation, or instability, is found to occur despite the fact that stirring mechanisms are used. That is, although the formulation may be maintained in a single phase in a holding tank due to constant agitation, separation of the phases occurs rapidly at the nozzle end, thereby resulting in uneven application over the fibres and/or clogging of the nozzles.

One solution to the stability problem has been proposed in PCT publication no. WO 95/06013. In this reference, there is taught the use of an emulsifier, which is combined with the mineral oil component prior to mixing with the binder. The emulsified oil and binder formulation is indicated as being stable during the application step through the nozzles. However, this reference does not provide any guidance on what emulsifiers are usable. Further, although the emulsified formulation, which is mixed just prior to the nozzle, remains stable during the application process, there is no indication or suggestion that such formulation can be pre-mixed and stored prior to the application step. Finally, the application procedure taught in this reference requires a relatively complicated apparatus in order to achieve the required pre-mixing.

Thus, there exists a need for an improved formulation comprising a binder and an anti-dusting combination that is sufficiently stable during the application over the glass or mineral fibres.

### SUMMARY OF THE INVENTION

In one aspect, the present invention provides a composition which overcomes at least one of the deficiencies in the known formulations. Specifically, the invention provides, in one embodiment, an anti-dusting formulation comprising an aqueous emulsion including the following components: a) a hydrocarbon; b) a triglyceride; and c) a surfactant. The formulation may also contain other known ancillary components. In one aspect, the triglyceride is present in the formulation in an amount of 10% to 100% (w/w) (expressed as a percentage of the oil phase). In another aspect, the triglyceride is present in an amount of 30% to 90% (w/w).

In another aspect, the invention provides an emulsion comprising a binder and an anti-dusting formulation consisting of an aqueous emulsion comprising: a) a hydrocarbon; b) a triglyceride; and c) a surfactant.

In another aspect, the present invention provides a method preparing a glass or mineral fibre product comprising the steps of:
forming a solution comprising the aforementioned anti-dusting formulation into an aqueous binder solution;
coating the glass or mineral fibres with the solution of binder and dust suppressant; and,
forming the fibres contacted with the adhesive binder into a non-woven mat, and heating the mat to cure the adhesive binder.

In a preferred embodiment, the hydrocarbon component comprises a petroleum derived hydrocarbon such as a mineral oil.

Thus, in one aspect, the invention provided an aqueous anti-dusting emulsion formulation for use in the manufacture of fibre wool insulation, the formulation comprising (on a w/w basis):
a) 0%-90% of a petroleum hydrocarbon;
b) 10%-100% of a triglyceride; and,
c) 1%-10% of a surfactant.

In another aspect, the invention provides an aqueous anti-dusting formulation for use in the manufacture of fibre wool insulation, the formulation comprising (on a w/w basis):
a) 0%-90% of a petroleum hydrocarbon selected from the group consisting of mineral oil, bright stock oil, paraffinic slack wax and petrolatum;
b) 10%-100% of a triglyceride selected from the group consisting of: palm oil, palm kernel oil, coconut oil, peanut oil, soybean oil, soy stearin, linseed oil, stearin oil, corn oil, cottonseed oil, rape seed oil, canola oil, sunflower oil, safflower oil, tung oil, castor oil, fish oil, lard, tallow, tall oil, animal fats, and mixtures thereof; and,
c) 1%-10% of a surfactant comprising a sodium or ammonium salt of a lignosulphonic acid.

In a further aspect, the invention provides a method for preparing a fibre wool insulation product comprising the steps of:
combining the anti-dusting emulsion formulation of the invention with a binding agent to form a mixture;
applying the mixture to the fibres;
forming the fibres into a non-woven mat; and,
heating the mat to cure the adhesive binder.

In yet a further aspect, the invention provides a fibre wool insulation product having incorporated therein an anti-dusting emulsion formulation as described herein.

### DETAILED DESCRIPTION OF THE INVENTION

In the present description, the terms listed below will be understood the have the following meanings:

“Fibre”—means any glass, mineral or other type of fibres used to manufacture insulation. Typically, glass fibres are used.

“Fibre wool”—means any wool-like insulation product made using fibres. Fibreglass and mineral wool (i.e. Rockwool™) are examples of such products.

“Binder”—means a binder or binding agent used to adhere fibres together in the process of manufacturing the insulation product. Such binders are generally known to persons skilled in the art. In one aspect of the invention, the binder comprises a phenolic resin. In one aspect, the phenolic resin comprises an aqueous phenol-formaldehyde condensation product) such as that commercially available from Dynea (www.dynea.com) under product no. 1957-16.

“Anti-dusting agent” or “de-dusting agent” or “dust suppressant”—mean additives applied to the fibres to reduce, suppress or prevent dust formation during formation of the fibres or during application of the fibres at an insulation site (i.e. the walls or attic etc. of a dwelling or structure). Anti-dusting agents are known in the art and may comprise, for example, petroleum based products. In one aspect, the anti-dusting agent comprises mineral oil. As used herein, the term “anti-dusting formulation” will be understood as being a formulation comprising an anti-dusting agent along with other additives.

Iodine value (IV)—is a measure of the iodine absorbed in a given time by a chemically unsaturated material. The IV number is used to measure the degree of unsaturation (i.e. the number of double bonds) of a compound or mixture.

Stability—refers to the quality or property of an emulsion to resist separation into its components or phases.

Lignosulphonate—refers to the reaction product of lignin, which is inherently obtained during sulphite pulping of wood, and is a principle constituent of spent sulphite liquor. Generally, the lignosulphonate comprises a calcium salt of lignosulphonic acid.

The present invention comprises, in one embodiment, an emulsion formulation for use as an anti-dusting additive in the manufacture of fibre insulation. The formulation, according
of the invention, comprises an aqueous emulsion comprising: (a) a petroleum based hydrocarbon; (b) a triglyceride; and, (c) a surfactant. In a preferred embodiment, the invention is particularly suited for use with fibreglass insulation. One example of such insulation is fibreglass batt insulation.

In one aspect of the present invention, the petroleum based hydrocarbon, component (a), comprises a mineral oil, bright stock oil, paraffinic slack wax or petrolatum. In a preferred embodiment, the hydrocarbon component has a minimum flashpoint of 450° F., or more preferably, a minimum flashpoint of 580° F., using a Cleveland open cup tester. In a preferred embodiment, the component (a) comprises a mineral oil. An example of a suitable hydrocarbon component is commercially available under the trade name Essoflex™ 571, manufactured by Imperial Oil, which is a common oil used as an anti-dusting agent in the fibreglass industry. In a preferred embodiment, the petroleum based hydrocarbon component is present in the anti-dusting formulation in the range of 10% to 70% (w/w).

In one aspect of the invention, component (b) preferably comprises triglycerides selected from: palm oil, palm kernel oil, palm stearin, coconut oil, peanut oil, soybean oil, soy stearin linseed oil, stearin oil, corn oil, cottonseed oil, rape seed oil, canola oil, sunflower oil, safflower oil, tung oil, castor oil, fish oil, lard, tallow, tall oil, animal fats, and mixtures thereof. Although the term “oil” is used above, it will be understood by persons skilled in the art that such oils are triglycerides. These components may be hydrogenated to low or very low iodine values (“IV”), thereby resulting in a high degree of saturation. Generally an IV value of below 130 is acceptable; however an IV value of less than 100 is preferred. In a preferred embodiment, the triglyceride component is present in the anti-dusting formulation in the range of approximately 30% to 90% (w/w). As indicated above, the triglyceride component is preferably highly saturated, and, preferably, has an IV value less than 130. Triglycerides having an IV greater than 130 are generally referred to as “drying oils”, which polymerize in the presence of oxygen and become brittle. Although such “drying” is not considered to affect the stability of the formulation, it would reduce its efficiency as an anti-dusting agent. For example, linseed oil is considered to be a drying oil. Soy oil is considered to be a semi-drying oil (i.e. an oil having an IV between 115 and 130). Palm oil is not considered to be a drying oil (i.e. an oil having an IV less than 115). As discussed below, in a preferred aspect of the invention, the triglyceride used in the formulation of the invention is refined, bleached and de-odorized (“RBD”) as opposed to a crude product. Such a RBD product was found to result in a more stable formulation.

In one aspect of the invention, the surfactant of the formulation, component (c), comprises a lignin based material such as lignosulphonic acid. More preferably, this component comprises an anionic sodium or ammonium salt of a lignosulphonic acid (i.e. a lignosulphonate). As indicated above, lignosulphonates are generally obtained as the by-product of the sulphite method for manufacturing paper from wood pulp. They are water soluble polymeric compounds and generally do not exhibit the amphiphilic structure of conventional surfactants. Even though they are anionic in nature, they are characterized by a high stability to changes in pH and electrolytic contamination. In a preferred embodiment, the surfactant component is present in the anti-dusting formulation in the range of 4% to 8% (w/w; i.e. dry weight of lignosulphonate/total product).

As discussed above, in the presence of strong phenolic binder systems emulsified oil products are often unstable, that is, they rapidly separate into their respective phases wherein, for example, the mineral oil/surfactant mixture separates from and rises to the surface of the phenolic binder solution phase. This instability results in various unwanted effects as discussed above. It has been found that the present invention results in a stable mineral oil/lignosulphonate and phenolic binder emulsion.

### Examples

The present invention will be further explained and illustrated by the following comparative examples and test results. These examples are intended to describe the advantageous properties of this invention and not to limit the invention in any way.

The following components were used in the test formulations:

| Com- | | |
|---|---|---|
| ponent | Description | Component Type |
| A | unmodified petroleum oil, | petroleum based |
| | Essoflex ™ 571 from Imperial Oil | hydrocarbon |
| B | unmodified soy oil, obtained from | triglyceride (may contain |
| | St. Lawrence Chemical | some free fatty acids) |
| C | hydrogenated soy oil, | triglyceride (may contain |
| | Naturewax ™ S-113 from Cargill | some free fatty acids) |
| D | palm stearin oil | triglyceride (may contain |
| | | some free fatty acids) |
| E | linseed oil | triglyceride (may contain |
| | | some free fatty acids) |
| F | unmodified petroleum oil, | petroleum based |
| | BS150, obtained from Ergon | hydrocarbon |
| G | high melt point slack wax | petroleum based |
| | obtained from PetroCanada | hydrocarbon |

For the tests, the following samples were prepared for the anti-dusting formulations:

| Sample | Method of Preparation |
|---|---|
| 1 | 44 parts of a component A (Essoflex ™ 571) was added to a solution of 50 parts |
| | water and 6 parts ammonium lignosulphonate under a high speed mixer, followed |
| | by homogenization at 3000 psi, and then cooling to ambient temperature. |
| 2 | As in 1 above, substituting component B for component A as the dispersed phase. |
| 3 | As in 1, substituting component C as the dispersed phase. |
| 4 | As in 1, substituting component D as the dispersed phase. |
| 5 | As in 1, using a 50:50 blend of component D and F as the dispersed phase. |
| 6 | As in 1, using component E as the dispersed phase. |
| 7 | As in 1, using component F as the dispersed phase. |
| 8 | As in 1, substituting component G as the dispersed phase. |
| 9 | As in sample preparation 3, substituting an alpha-olefin maleic anhydride |
| | copolymer (OMA ™ 30 from Luxco) for the ammonium lignosulphonate, and with |
| | sufficient quantity of an ethanolamine to produce an alkaline emulsion. |

### Comparative Tests:

In order to evaluate the dispersive quality of the anti-dusting emulsion formulations in a binder solution, 6 parts of each of the above listed emulsions were added to 100 parts of a phenolic resin (15.0% in water). The phenolic resin was a powdered resin obtained from DYNEA (product no. 1957-16). The final mixture was agitated vigorously for 1 minute and then allowed to settle. Typically an unstable dispersion in the binder will begin to flocculate, and then exhibit a clear separation of phenolic solution from the aqueous emulsion, with the oil phase rising to the surface. The amount of separation (measured as the percentage of phenolic solution clearly observed) and phasing of the various samples were recorded. The results of these tests are summarized in the following table.

### Test Results:

| Sample | Separation at 15 min | Separation at 1 hour |
|---|---|---|
| 1 | 80% | Complete separation |
| 2 | No separation | No Separation |
| 3 | No separation | No separation, s.f.* |
| 4 | No separation | 70% separation |
| 5 | No separation | No separation, s.f.* |
| 6 | No separation | No separation |
| 7 | 80% | Complete separation |
| 8 | 15% | 75% |
| 9 | 10% | 50% |

*s.f. indicates slight flocculation, which occurs in the initial stage before product separation.

As can be seen from the above results, the samples containing the triglyceride and lignosulphonate combinations remained dispersed in the binder solution for a much greater length of time. The sample comprising OMA as the surfactant (Sample 9) did not provide the same results as the samples wherein lignosulphonate was used as the surfactant.

There also seems to be some synergistic effect in the blended oil/triglyceride composition, as observed in the results of comparative tests 4 and 5. The unexpected stability of the lignosulphonate/triglyceride compositions allows for a more efficient application of the dust suppressant as compared to the formulations containing only lignosulphonate and petroleum hydrocarbon components (i.e. samples 1 and 7).

As indicated above, Samples containing only the lignosulphonate (surfactant) and triglyceride (oil) were found to be stable despite the absence of a petroleum based hydrocarbon component. However, as discussed above, it is assumed that the samples incorporating a “drying oil”, i.e. with an IV less than 115, will not provide the desired anti-dusting characteristics.

The results of the above tests also indicate that there are specific blends of triglycerides that provide increased levels of stability and dispersion in the phenolic binder system. It is important to note that vegetable oils are mixtures of triglycerides from various fatty acids, and that the general composition is variable in nature. On average, however, oils that are obtained from different sources, such as soy or corn or palm, for example, can be distinguished by the relative composition of fatty acids in the range of C14 to C22, and the relative degree of unsaturation indicated by the iodine value.

It should also be noted that in testing of the formulations of the invention, it was noted that a refined, bleached and de-odorized triglyceride was found to result in improved stability as compared to formulations including crude triglyceride. This was found to be particularly the case where the triglyceride was soybean oil.

Although the above description has focussed on anti-dusting emulsion formulations, it will be understood that also encompassed within the scope of the invention are fibre-wool insulation products that incorporate such formulations and the methods of making such insulation products.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The disclosures of all prior art recited herein are incorporated herein by reference in their entirety.

1. An aqueous anti-dusting emulsion formulation for use in the manufacture of fibre wool insulation, the formulation comprising:
a) a petroleum hydrocarbon;
b) a triglyceride; and,
c) a surfactant.

2. The formulation of claim 1 comprising:
a) less than 90% (w/w) of a petroleum hydrocarbon;
b) 10%-100% (w/w) of a triglyceride; and,
c) 1%-10% (w/w) of a surfactant.

3. The formulation of claim 1 wherein the triglyceride is present in an amount from 30% to 90% (w/w).

4. The formulation of claim 1 wherein the hydrocarbon is selected from the group consisting of mineral oil, bright stock oil, paraffinic slack wax and petrolatum.

5. The formulation of claim 1 wherein the hydrocarbon has a flash point above 450° F.

6. The formulation of claim 5 wherein the hydrocarbon has a flash point above 550° F.

7. The formulation of claim 1 wherein triglyceride is selected from the group consisting of: palm oil, palm kernel oil, coconut oil, peanut oil, soybean oil, soy stearin, linseed oil, stearin oil, corn oil, cottonseed oil, rape seed oil, canola oil, sunflower oil, safflower oil, tung oil, castor oil, fish oil, lard, tallow, tall oil, animal fats, and mixtures thereof.

8. The formulation of claim 7 wherein triglyceride is hydrogenated to iodine values below 130.

9. The formulation of claim 7 wherein triglyceride has a flashpoint above 550° F.

10. The formulation of claim 1 wherein the surfactant is a sodium or ammonium salt of a lignosulphonic acid.

11. The formulation of claim 1 further comprising a binding agent.

12. The formulation of claim 11 wherein the binding agent is a phenolic resin.

13. The formulation of claim 1 wherein the triglyceride component is refined, bleached and de-odorized.

14. An aqueous anti-dusting emulsion formulation for use in the manufacture of fibre wool insulation, the formulation comprising:
a) less than 90% (w/w) of a petroleum hydrocarbon selected from the group consisting of mineral oil, bright stock oil, paraffinic slack wax and petrolatum;
b) 10%-100% (w/w) of a triglyceride selected from the group consisting of: palm oil, palm kernel oil, coconut oil, peanut oil, soybean oil, soy stearin, linseed oil, stearin oil, corn oil, cottonseed oil, rape seed oil, canola oil, sunflower oil, safflower oil, tung oil, castor oil, fish oil, lard, tallow, tall oil, animal fats, and mixtures thereof; and,
c) 1%-10% (w/w) of a surfactant comprising a sodium or ammonium salt of a lignosulphonic acid.

15. The formulation of claim 14 wherein the triglyceride is present in an amount from 30% to 90% (w/w).

16. The formulation of claim 14 further comprising a binding agent comprising a phenolic resin.

17. The formulation of claim 16 wherein the triglyceride component is refined, bleached and de-odorized.

18. A method for preparing a fibre wool insulation product comprising the steps of:
combining the anti-dusting formulation of claim 17 with a binding agent to form a mixture;
applying said mixture to the fibres;
forming the fibres into a non-woven mat; and,
heating the mat to cure the adhesive binder.

19. A fibre wool insulation product having incorporated therein the aqueous anti-dusting emulsion formulation according to claim 1.

20. A fibre wool insulation product having incorporated therein the aqueous anti-dusting emulsion formulation according to claim 14.
